(19) United States
(12) Patent Application Publication
(10) Pub. No.: US 2010/0125487 A1
(43) Pub. Date: May 20, 2010

(54) System and method for estimating settings for managing a supply chain

(75) Inventors: Eric Vincent Sinclair, Morton, IL (US); Seth Ryan Pacha, Metamora, IL (US); Kara Kathleen Knepp, Morton, IL (US); Aaron Andrew Evans, East Peoria, IL (US); Christopher Anthony Carrico, Metamora, IL (US); Scott Dwayne Skonieczny, Grand Blanc, MI (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 12/291,961

(22) Filed: Nov. 14, 2008

(51) Int. Cl. G06Q 10/00

(52) U.S. Cl. 705/10; 705/7

(57) ABSTRACT

A method for estimating supply chain settings comprises receiving historical supply chain data and generating one or more supply chain simulation files based on the historical supply chain data. A plurality of supply chain settings associated with the one or more supply chain simulation files is established and the one or more supply chain simulation files are simulated based on the plurality of supply chain settings. The performance of the supply chain is predicted over a time period associated with the historical supply chain data based on the simulation, and data indicative of the predicted performance of the supply chain is provided to a subscriber.

### TECHNICAL FIELD

The present disclosure relates generally to supply chain management and, more particularly, to a system and method for estimating settings for managing a supply chain.

### BACKGROUND

Supply chain management is an integral part of almost any business that engages in the manufacture, sale, and/or distribution of goods. Supply chain management typically involves a plurality of interrelated sub-processes that manage and control virtually every aspect associated with the production and delivery of a finished product to an end-user—from the acquisition and distribution of raw materials between a supplier and a manufacturer, to the manufacturing and production of the finished product, through the delivery, distribution, and storage of materials for a retailer or wholesaler, and, finally, to the sale of the finished good to an end-user.

A primary goal of supply chain management is to ensure that sufficient product is available to the customer at the time and location required by the customer. While product availability is critical to effective supply chain management, another goal of supply chain management includes avoidance of the introduction of excessive amounts of product into the supply chain. By avoiding over-production, effective supply chain management solutions seek to limit the expenditure of capital resources that fail to provide a high likelihood of potential for return on investment. For example, unsold or overstocked product may necessitate additional storage space, maintenance facilities and resources, and expenditure of capital for production, raw material procurement, handling, delivery, etc.,—capital that cannot otherwise be invested or employed in pursuit of an alternative endeavor.

Typically, suppliers of retail and wholesale products focus a majority of time, effort, and capital in researching, developing, manufacturing, marketing, and advertising their product(s). Consequently, many suppliers may not have the experience necessary to effectively and efficiently manage a supply chain. Moreover, as the number of facilities associated with the supply chain increases, the complexity associated with estimating supply chain parameters (e.g., product demand analysis and forecasting, determination of minimum safety stock levels, determination of appropriate deployment settings, optimization of shipping routes, facility planning, etc.) also increases. Consequently, suppliers having supply chains that contain multiple distribution facilities, warehouses, retail centers, manufacturing facilities, etc. may be especially vulnerable to supply chain management inefficiencies.

The increasing complexity required to effectively manage large supply chains has prompted development of supply chain software simulation tools. Such software simulation tools typically provide an interface that allows users to develop software models of facilities associated with the supply chain. Users may establish/adjust certain settings associated with the software model(s), such settings being representative of parameters associated with operations and performance of an actual facility. A software simulation tool may subsequently simulate the software model to estimate or predict a future performance of the supply chain in response to the adjusted settings.

While conventional software simulation tools may allow the user to analyze the effects of proposed supply chain management settings more quickly than observing effects of adjustments to the settings in the actual supply chain, such tools are often too complicated for a user possessing no significant supply chain management experience. For example, a typical supply chain facility may allow the user to adjust one of several supply chain management parameters associated with each part in the facility, with each parameter being independently adjusted to produce a different effect in the overall operation of the supply chain. For supply chains with multiple facilities, each facility potentially housing thousands of different part numbers, supply chain management may quickly become a complicated endeavor, particularly for organizations that rely on inexperienced or unsophisticated supply chain management resources. Thus, in order to effectively and efficiently estimate supply chain management parameters in a product supply environment, systems and methods for efficiently predicting and establishing accurate parameters for each facility associated with the supply chain, may be required.

One method for estimating supply chain parameters is described in U.S. Patent Publication No. 2002/0156663 to Weber et al. (“the '663 publication”). The '663 publication discloses a supply chain management method, wherein a user may establish a supply chain model, specify certain supply chain optimization conditions, analyze the model using the optimization conditions, and adjust the supply chain model based on the analysis. The method of the '663 publication discloses establishing a plurality of goals for the optimization of the supply chain (e.g., minimize costs, maximize profits, maximize sales volume, etc.) The supply chain model is then optimized using a combination of linear programming and mixed integer programming techniques to identify an impact associated with a plurality of supply chain management solutions.

Although the method disclosed in the '663 publication may allow users to optimize supply chain characteristics based on one or more predetermined goals, it may not be sufficient. For example, the method disclosed in the '663 publication may not allow users to simulate adjusted supply chain parameters over a particular historical time period to, for instance, retrospectively analyze the supply chain based on the adjusted settings. Furthermore, because the method described in the '663 publication simply identifies optimal supply chain characteristics based on a general optimization goal set for the entire supply chain, it may not provide organizations with a solution for predicting how adjustments to particular supply chain parameters (e.g., transactions at the facility level, order level, and/or line level) may effect the supply chain. As a result, while the method described in the '663 publication may provide a general solution for determining conformance of certain supply chain settings to an overarching optimization goal in certain situations, it may not provide a solution that allows users to analyze the effects of the individual supply chain settings on particular facilities, parts, and/or transactions.

Furthermore, the optimization method disclosed in the '663 publication may be inefficient. For example, in order to investigate the impact associated with changes to a particular feature, such as how a change in inventory level at particular distribution center may effect the service level of one or more part numbers, the method of the '663 publication may require execution of the entire optimization model, including forecast models, inventory planning models, and models that may be wholly unrelated to the inventory level of the distribution center. As a result, the method of the '663 publication may waste valuable time optimizing (and/or re-optimizing) certain models that may not be affected by changes to certain supply chain features.

The presently disclosed systems and methods for estimating supply chain settings are directed toward overcoming one or more of the problems set forth above.

### SUMMARY

In accordance with one aspect, the present disclosure is directed toward a method for estimating supply chain settings. The method may comprise receiving historical supply chain data and generating one or more supply chain simulation files based on the historical supply chain data. A plurality of supply chain settings associated with the one or more supply chain simulation files may be established and the one or more supply chain simulation files may be simulated based on the plurality of supply chain settings. The performance of the supply chain may be predicted over a time period associated with the historical supply chain data based on the simulation, and data indicative of the predicted performance of the supply chain may be provided to a subscriber.

According to another aspect, the present disclosure is directed toward a computer-readable medium for use on a computer system, the computer-readable medium including computer-executable instructions for performing a method for estimating control settings in a supply chain environment. The method may comprise receiving historical supply chain data and generating one or more supply chain simulation files based on the historical supply chain data. A plurality of supply chain settings associated with the one or more supply chain simulation files may be established and the one or more supply chain simulation files may be simulated based on the plurality of supply chain settings. The performance of the supply chain may be predicted over a time period associated with the historical supply chain data, based on the simulation, and data indicative of the predicted performance of the supply chain may be generated.

In accordance with another aspect, the present disclosure is directed toward a method for estimating supply chain settings. The method may comprise receiving historical supply chain data and generating one or more supply chain simulation files based on the historical supply chain data. A plurality of supply chain settings associated with the one or more supply chain simulation files may be established, and the one or more supply chain simulation files based on the plurality of supply chain settings may be simulated. Performance of the supply chain may be predicted over a time period associated with the historical supply chain data based on the simulation, and the predicted performance of the supply chain may be compared with target performance criteria. Actual supply chain settings may be adjusted based on the plurality of supply chain settings if the predicted performance of the supply chain is within a threshold range of the target performance criteria.

### BRIEF DESCRIPTION OF THE DRAWINGS

FIG. 1 illustrates an exemplary supply chain management environment in which processes and methods consistent with the disclosed embodiments may be implemented;

FIG. 2 provides a flowchart depicting an exemplary method for estimating supply chain management parameters, in accordance with the disclosed embodiments;

FIG. 3 provides a flowchart illustrating another exemplary method for estimating supply chain parameters, in accordance with certain disclosed embodiments; and

FIG. 4 provides an illustration of an exemplary output associated with the supply chain management environment illustrated in FIG. 1.

### DETAILED DESCRIPTION

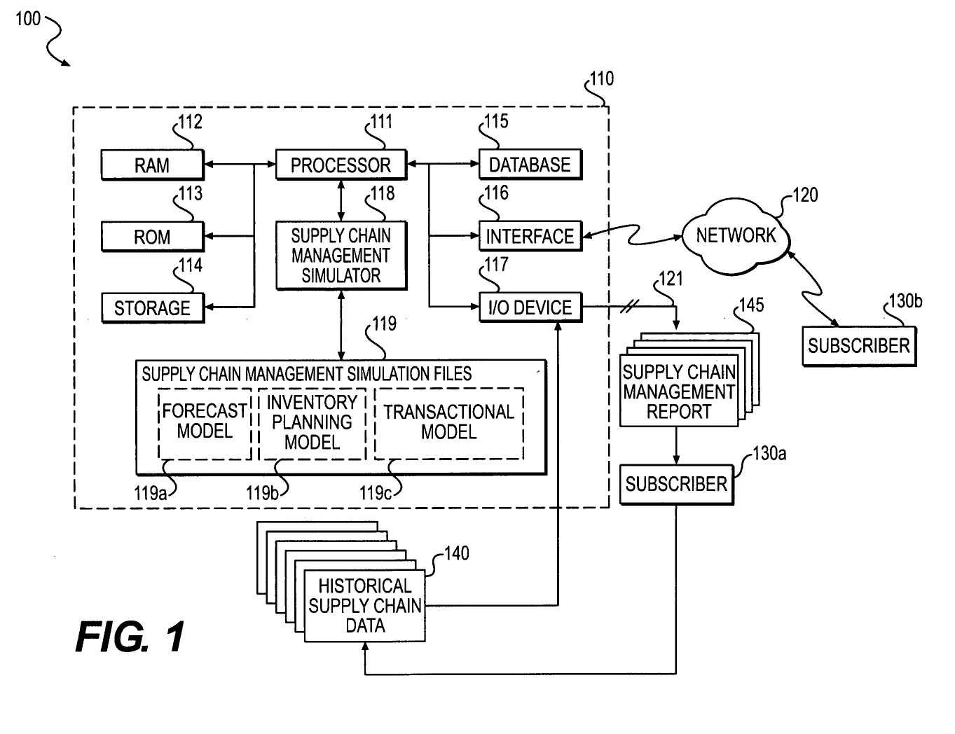

FIG. 1 illustrates an exemplary supply chain environment 100 in which processes and methods consistent with the disclosed embodiments may be implemented. Specifically, supply chain environment 100 may include any computer or software environment that facilitates the design, implementation, and analysis of supply chain management solutions. As illustrated in FIG. 1, supply chain environment 100 may include a system 110 for estimating various parameters or settings associated with a supply chain. Supply chain environment 100 may also include subscriber systems 130a, 130b coupled to system 110 by way of a network 120 and/or direct link 121, thereby enabling the transfer of information and data (e.g., historical supply chain data 140, supply chain management assessment report(s) 145, etc.) between subscriber systems 130a, 130b and system 110.

Supply chain management, as the term is used herein, refers to a process for determining settings that may be implemented by a customer or business looking to improve the performance, efficiency, and profitability of its supply chain. Because supply chains may include multiple facilities, such as, for example, manufacturing plant(s), distribution center(s), storage warehouse(s), retail center(s), repair facilities, etc., each facility potentially including a large quantity of part numbers for distribution to one or more other facilities or a final sale to a customer, supply chain management may be a multi-faceted task. Specifically, supply chain management typically involves one or more processes for increasing supply chain efficiency and productivity including, for example, processes for: determining and establishing core stock levels at sourcing facilities (e.g., distribution center(s) and warehouse(s)) to meet forecasted customer demand; estimating appropriate safety stock levels based on seasonal demand, trend demand, normal (random), and sporadic demand; establishing replenishment schedules for maintaining stock levels; management and planning of vendor lead-times to ensure that product sourcing requirements are met; management of part supersession schedules for efficient transition to new products. It is contemplated that supply chain management may involve additional, fewer, and/or different processes for increasing supply chain efficiency and productivity than those listed above. The processes listed above are exemplary only and not intended to be limiting. The systems and methods described herein provide an integrated solution for estimating and adjusting supply chain parameters based on historical customer supply chain data in order to meet target operational and/or performance requirements of the supply chain in accordance with a customer cost structure.

Supply chain parameters (or settings) may include one or more settings associated with one or more parts, facilities, vendors, suppliers, or distributors associated with a supply chain that may effect operation and/or performance of the supply chain. For example, supply chain parameters may include demand forecast settings or models that may be used to estimate part stocking levels. Demand forecast models may include seasonal demand models, sporadic demand models, linear regression models, or regular (flat) demand model. Supply chain parameters may also include one or more of inventory planning parameters (e.g., target service level, economic order quantity (EOQ) limit settings, safety stock levels (for a part and/or facility); DRP settings; stocking decision settings; deployment settings; or deployment priority). Each supply chain parameter may be established and adjusted to influence operation or performance of the supply chain. The systems and methods described herein provide a method for identifying, isolating, and establishing supply chain settings that improve supply chain performance in an attempt to meet a desired supply chain performance level.

Processes and methods consistent with the disclosed embodiments provide a software solution that allows users to simulate performance of a supply chain under different sets of supply chain settings. The simulation software may output simulated operation/performance data associated with the supply chain. Supply chain operation/performance data may include any parameter or value that may be indicative of performance of an aspect of the supply chain. For example, operational/performance data may include a number of inbound/outbound lines associated with a part facility, peak on-hand data associated with a part or group of parts, a number of sales associated with each part, an actual on hand quantity of each part stocked at each facility, a safety stock level for each part at each facility, a number and frequency of parts deployments to and from each facility, or any other aspect associated with operation of the supply chain, service level associated with each part at each facility, and effective (average) service level associated with the supply chain. Supply chain operation/performance data may also include an inventory cost associated with implementation of the supply chain parameters that were used to produce the operation/performance data. It is contemplated that operation/performance data associated with the supply chain may include additional, fewer, and/or different parameters than those listed above. Indeed, supply chain operation/performance data may include any parameter that depends, either directly or indirectly, on one or more supply chain settings.

System 110 may include any type of processor-based system on which processes and methods consistent with the disclosed embodiments may be implemented. As illustrated in FIG. 1, system 110 may include one or more hardware and/or software components configured to execute software programs, such as software for managing supply chain environment 100. For example, system 110 may include one or more hardware components such as, for example, processor 111 (e.g., CPU), a random access memory (RAM) module 112, a read-only memory (ROM) module 113, a storage device 114, a database 115, an interface 116, and one or more input/output (I/O) devices 117. Alternatively and/or additionally, system 110 may include one or more software components such as, for example, a computer-readable medium including computer-executable instructions for performing methods consistent with certain disclosed embodiments. It is contemplated that one or more of the hardware components listed above may be implemented using software. For example, storage 114 may include a software partition associated with one or more other hardware components of system 110. System 110 may include additional, fewer, and/or different components than those listed above. It is understood that the components listed above are exemplary only and not intended to be limiting.

Processor 111 may include one or more processors, each configured to execute instructions and process data to perform one or more functions associated with system 110. As illustrated in FIG. 1, processor 111 may be communicatively coupled to RAM 112, ROM 113, storage 114, database 115, interface 116, and I/O devices 117. Processor 111 may be configured to execute sequences of computer program instructions to perform various processes, which will be described in detail below. The computer program instructions may be loaded into RAM for execution by processor 111.

RAM 112 and ROM 113 may each include one or more devices for storing information associated with an operation of system 110 and/or processor 111. For example, ROM 113 may include a memory device configured to access and store information associated with system 110, including information for identifying, initializing, and monitoring the operation of one or more components and subsystems of system 110. RAM 112 may include a memory device for storing data associated with one or more operations of processor 111. For example, ROM 113 may load instructions into RAM 112 for execution by processor 111.

Storage 114 may include any type of mass storage device configured to store information that processor 111 may need to perform processes consistent with the disclosed embodiments. For example, storage 114 may include one or more magnetic and/or optical disk devices, such as hard drives, CD-ROMs, DVD-ROMs, or any other type of mass media device.

Database 115 may include one or more software and/or hardware components that cooperate to store, organize, sort, filter, and/or arrange data used by system 110 and/or processor 111. For example, database 115 may be used to store and organize historical demand data, including part number records, inventory records, sales records, distribution records, historical and seasonal demand information, and any other data records that may be suitable for organization in a database. Processor 111 may access the information stored in database 115 in order to retrieve information for building supply chain simulation files, forecast model(s), inventory planning model(s), and transactional model(s) associated with a supply chain. It is contemplated that database 115 may store additional and/or different information than that listed above.

Interface 116 may include one or more components configured to transmit and receive data via a communication network, such as the Internet, a local area network, a workstation peer-to-peer network, a direct link network, a wireless network, or any other suitable communication platform. For example, interface 116 may include one or more modulators, demodulators, multiplexers, demultiplexers, network communication devices, wireless devices, antennas, modems, and any other type of device configured to enable data communication via a communication network.

I/O devices 117 may include one or more components configured to communicate information with users associated with system 110. For example, I/O devices may include a console with an integrated keyboard and mouse to allow users to input parameters associated with system 110. I/O devices 117 may also include a display including a graphical user interface (GUI) for outputting information on a monitor. I/O devices 117 may also include peripheral devices such as, for example, a printer for printing information associated with system 110, a user-accessible disk drive (e.g., a USB port, a floppy, CD-ROM, or DVD-ROM drive, etc.) that allows users to input data stored on a portable media device, a microphone, a speaker system, or any other suitable type of interface device.

System 110 may also include one or more software simulation applications configured to allow a user (e.g., subscribers 130a, 130b) to construct supply chain simulation files and models associated with such files, simulate the supply chain models to predict supply chain performance under different sets of supply chain settings/conditions, and identify/estimate, based on the simulations, specific supply parameters that enhance, among other things, the efficiency, cost structure, and service level associated with the supply chain. For example, system 110 may include a supply chain management software simulator 118 configured to simulate supply chain management simulation models 119a-c representative of actual facilities and/or characteristics associated with the supply chain. Supply chain software simulator 118 allows organizations to predict and analyze how changes in supply chain parameters will impact the operation/performance of the supply chain using a software representation of the supply chain, without requiring modification or interference with the actual supply chain. By predicting and testing how changes in supply chain parameters impact supply chain performance before modifying settings associated with the actual supply chain, negative impacts that trial-and-error testing may have on real-time business productivity may be limited and/or mitigated.

System 110 may be in data communication with subscribers 130a, 130b and may be configured to exchange information with subscribers 130a, 130b via I/O device(s) 117 and/or interface 116. For example, system 110 may be configured to receive, download, and/or access historical supply chain data 140 and other records stored on computer systems associated with subscribers 130a, 130b. Alternatively or additionally, system 110 may be configured to transmit, upload, or otherwise deliver supply chain management assessment report(s) 145 or other data summarizing supply chain simulation results and analysis performed by system 110. Historical supply chain data is defined in greater detail below.

Supply chain simulator 118 may include any suitable data simulator that is configured to simulate supply chain management simulation files 119 including demand forecast models, inventory planning models, transactional models, or any other type of model associated with a supply chain. According to one embodiment, supply chain simulator 118 embodies a proprietary software simulation tool that may be customized to interact with proprietary supply chain simulation models. Alternatively or additionally, supply chain simulator 118 may embody an existing supply chain management simulation tool that is packaged as part of a suite of logistics tools and has been customized or modified to meet the requirements of a particular customer.

Supply chain simulator 118 may be configured to interact with a plurality of supply chain simulation files 119 to predict behavior associated with a supply chain, based on the interrelationship between behavioral algorithms derived for actual characteristics associated with supply chain environment 110. Supply chain simulation files 119 may be loaded into and executed by supply chain simulator 118 to predict performance parameters of the supply chain under a variety of operating conditions. For example, a user may specify certain simulation conditions under which supply chain simulation files 119 will be evaluated and identify the features to be predicted by the simulation. During execution of the supply chain simulation files 119, supply chain simulator 118 may initialize and exercise the supply chain simulation files 119 under the user-specified simulation conditions to predict responses or behaviors of the supply chain to the simulation conditions. Through iterative adjustment and analysis of supply chain parameters, supply chain simulator 118 may identify trends in certain aspects of the supply chain and determine supply chain parameters that exhibit the appropriate balance between cost and supply chain performance (e.g., customer service level.)

For example, in order to identify effect(s) a change in an inventory level associated with a particular part number at a particular distribution center has on the overall service level associated with the part, a user may, via a graphical user interface associated with the supply chain simulator 118, adjust a parameter of a supply chain simulation file 119 that represents a safety stock associated with the part number at the particular distribution center. Supply chain simulator 118 may simulate supply chain simulation files 119 based on the adjusted inventory level for the part number and output the service level corresponding to the simulated change.

Supply chain simulation files 119 may include a plurality of models, each of which may be representative of a different aspect or feature associated with the supply chain. Specifically, supply chain simulation files 119 may include a demand forecast model 119a, an inventory planning model 119b, and a transactional model 119c. It is contemplated that supply chain simulation files 119 may include additional, fewer, and/or different models than those listed above. For example, supply chain simulation files 119 may include a distribution model (not shown) that enables the simulation of distribution between or among different supply chain facilities. Alternatively or additionally, supply chain simulation files 119 may include a facilities evaluation model that performs cost/benefit analysis associated with adding new (or modifying/relocating existing) facilities in the supply chain network.

Forecast model 119a may include a software data model configured to predict the demand forecast for one or more part numbers or groups of part numbers. According to one embodiment, forecast model 119a associated with one or more parts or groups of parts may be derived from historical supply chain data 140 associated with the supply chain. For example, supply chain simulator 118 may construct forecast model 119a from order information for each part number over a particular historical time period ranging from 12-60 months. Once constructed, forecast model 119a may be configured to identify trends in the historical data in view of present activity associated with each part number, in order to predict a future demand for the part number.

According to one embodiment, forecast model 119a may be generated automatically using model derivation software, which automatically generates models by evaluating trends in the historical demand data. According to another embodiment, forecast model 119a may be generated manually, through iterative manual analysis of the historical demand data and computer programming techniques. In any event, forecast model 119a may be generated as an integral part of the supply chain management analysis scheme by system 110. Alternatively or additionally, forecast model 119a may be generated and/or supplied by a subscriber, separately and independently from the supply chain analysis method described herein. In yet another alternative, forecast model 119a may be selected from a plurality of predetermined forecast model (e.g., seasonal demand models, sporadic demand models, linear regression models, or regular (flat) demand models), which may be provided to aid forecasting of new part numbers or part numbers that may have limited historical data available.

Inventory planning model(s) 119b may embody a software data model configured to predict inventory stocking settings associated with each part number or group of part numbers. Inventory stocking settings may include, for example, economic order quantities (EOQs) associated with part numbers at each facility, safety stock level, inventory replenishment minimums and maximums, inventory allocation, and/or any other setting that may relate to the inventory stocking settings for a part number or group of part numbers. According to one embodiment, supply chain simulation files 119 may include a plurality of inventory planning models, each model corresponding to a particular facility associated with a supply chain. For example, each distribution center or storage facility may be represented by a single inventory planning model 119b, each planning model including supply chain data associated with each part number or group of part numbers stored or sourced in the facility.

Transactional model 119c may include a software data model configured to predict transactions associated with each part number or group of part numbers. According to one embodiment, transactional model 119c may be based on historical transaction data associated with the historical supply chain data received from a customer. Accordingly, transactional model 119c may be configured to predict, based on trends in past transactional data as well as growth predictions extrapolated from the historical data, the number and type of transactions associated with each part number for a particular facility. For example, transactional model 119a may be configured to predict the inflow (e.g., units received) and outflow (e.g., units sold, shipped, or transferred) of a part number or group of part numbers associated with a facility. Similar to inventory planning model 119b, supply chain simulation files 119 may include a plurality of transactional models, each model corresponding to a particular facility associated with a supply chain.

According to one embodiment, transactional model 119a may be configured to estimate and predict growth and recession patterns associated with transactions at a particular facility. For example, transactional model 119a may be configured to predict a recession in the number of transactions for a central distribution center that may be associated with construction of a nearby regional distribution center that will bear some of the transactional burden of the central distribution center. Similarly, transactional model 119a may be configured to predict growth in the number of transactions for a retail center associated with increased customer demand for the part number.

Communication network 120 may include any network that provides two-way communication between system 110 and an off-board system, such as subscriber systems 130a, 130b. For example, communication network 120 may communicatively couple subscribers 130a, 130b to system 110 across a wireless networking platform such as, for example, a satellite communication system. Alternatively and/or additionally, communication network 120 may include one or more broadband communication platforms appropriate for communicatively coupling one or more subscribers 130a, 130b to system 110 such as, for example, cellular, Bluetooth, microwave, point-to-point wireless, point-to-multipoint wireless, multipoint-to-multipoint wireless, or any other appropriate communication platform for networking a number of components. Although communication network 120 is illustrated as a satellite wireless communication network, it is contemplated that communication network 120 may include wireline networks such as, for example, Ethernet, fiber optic, waveguide, or any other type of wired communication network.

Direct link 121 may include any device or system that enables direct communication between subscriber 130a and system 110. For example, direct link 121 may include a wireline link (e.g., peer-to-peer Ethernet, USB, FireWire, etc.) configured to enable direct communication between subscriber 130a and system 110. Alternatively or additionally, direct link 121 may embody a wireless communication link such as, for example, a Bluetooth link, peer-to-peer wireless link, or any other suitable direct wireless communication platform that enable direct transfer of information between subscriber 130a and system 110.

Subscribers 130a, 130b may each include a computer system associated with a business entity, organization, or individual associated with the supply chain. Subscribers 130a, 130b may include, for example, a computer system that includes the inventory management records associated with a manufacturer, distributor, and or retailer of goods. According to one exemplary embodiment, subscribers 130a, 130b may be associated with a customer corresponding to a company involved in the manufacture and distribution of service parts.

Subscribers 130a, 130b may provide historical supply chain data 140 and/or other information associated with a supply chain, which may aid system 110 in estimating and/or improving supply chain parameters for the supply chain. Subscribers 130a, 130b may also receive supply chain management assessment report(s) 145 summarizing supply chain analysis performed by system 110. The types of information provided by and the formatting of historical supply chain data 140 and supply chain management assessment report(s) 145 will be described in further detail below.

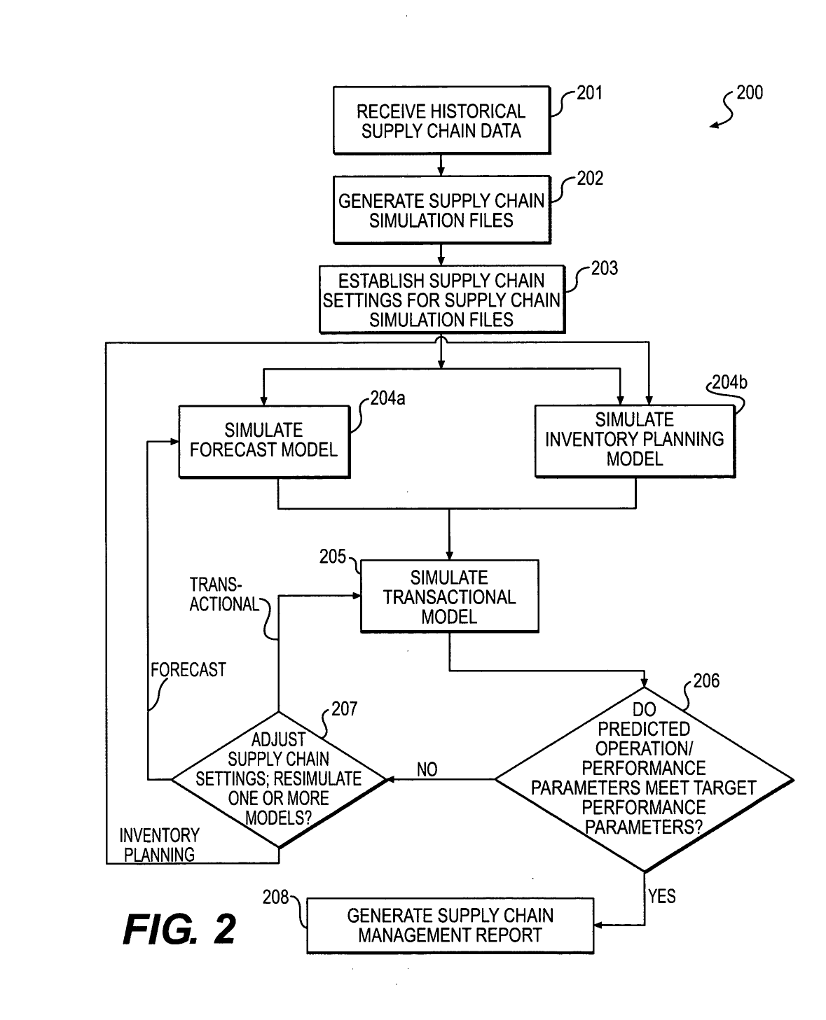

FIG. 2 provides a flowchart depicting an exemplary method for estimating settings for managing a supply chain, in accordance with certain disclosed embodiments. The process may commence upon receipt of historical supply chain data 140 from a client or customer, such as subscriber 130a, 130b (Step 201). Historical supply chain data 140 may include information related to the management of inventory associated with a supply chain over a particular historical time period (e.g., last 12 months, 18 months, etc.) According to one exemplary embodiment, historical supply chain data 140 may include transactional demand data, part master information, part on-hand information, part supersession information, customer information, and bill of distribution (BOD) information. It is contemplated that additional, fewer, and/or different supply chain information may be included with historical supply chain data 140, and that the information listed above is exemplary only and not intended to be limiting.

Transactional demand data may include information associated with the number of requests for transactions associated with each part number at a particular facility, such as a distribution facility, retail center, manufacturing facility, or any other inventory location. For example, transactional demand data may include inventory, demand, or sales information from a plurality of facilities in a supply chain network, each record including the number of transactions (e.g., orders, shipments made, returns, etc.) placed by external (e.g., end-user customers) and/or internal (e.g., other facilities within the supply chain network) for each part number housed within the facility.

Part master information may include general information associated with each part number in the supply chain. Part master information may include, for example, the part number, the stock-keeping unit (SKU) number, the manufacturer or original source information, product origination information (e.g., when product entered the supply chain), the total quantity of units in the supply chain, vendor lead time, part cost, or any other general information associated with each of the part numbers in the supply chain.

Part on-hand information may include information associated with parts that are currently stocked in one or more of the supply chain facilities. In contrast, part master information includes inventory records for all parts associated with the supply chain, regardless of whether the part is actually stored in inventory at a particular time period. Part on-hand information includes data indicative of the number of parts stocked in each of supply chain facilities. Part on-hand information may include a current number of parts stored in inventory, minimum and maximum replenishment values, bin or shelf location, and any other information associated with the part.

Supersession information may include information linking generations of different part numbers with predecessor or successor parts. For example, supersession information may include information linking a particular part number with a previous and/or subsequent version of the part. For example, as improvements or adjustments are made to a design or manufacture of a part, a new version of the part may be introduced into the supply chain, while the older version is phased out of the supply chain. Because the customer demand for the “old” part is still relevant to the “new” part (which will likely be assigned a part number and SKU different than the old part), supersession information may be used to cross-reference or otherwise link data associated with the old and new versions of the part.

Customer information may include data related to particular customers (e.g., part wholesalers, retailers, end-users, etc.) in the supply chain. Customer information may include any information about the customer that may influence a present or future operation or management of the supply chain such as, for example, customer location(s), historic customer order information (e.g., part number, quantity, etc.), customer delivery times, contractual obligations to a customer (e.g., minimum service level), or any other information that may impact inventory or supply chain management. For example, location of a customer may influence decisions regarding demand growth or decline in a particular geographical region associated with the supply chain.

Once historical supply chain data 140 has been gathered, supply chain simulation files 119 may be generated (Step 202). Supply chain simulation files 119 may be generated automatically by, for example, a software model generation tool that creates inventory analysis models based on analysis of historical supply chain data. Alternatively or additionally, supply chain simulation files 119 may be generated manually by, for example, experienced logistics, supply chain, and software development professionals that are capable of generating software models by analyzing the historical supply chain data, predicting/deriving supply chain behavior based on the analysis, and coding the behavioral patterns into a simulation data model.

As part of the supply chain simulation file generation process, historical supply chain data 140 may be “purified” to remove or filter certain aspects of the historical data that may cause an error in the analysis of the data. For example, the historical supply chain data 140 may be filtered to exclude certain part numbers that may be new to the inventory and, therefore, do not possess adequate or accurate historical information to provide reliable demand and inventory planning forecasts. Similarly, inventory items that contain inadequate inventory record information may be excluded from historical supply chain data 140. For instance, supply chain data associated with part numbers that do not include cost information or vendor lead-time data may be excluded, as the information missing from these part numbers may result in erroneous simulations. Alternatively or additionally, historical supply chain data 140 may be filtered to remove certain specialized or customized part numbers, as such part numbers may not be introduced into the supply chain. It is contemplated that the data purification process may be performed using manual techniques, automated methods (e.g., computer-implemented software), or a combination of manual and automated methods.

The data purification process may yield a plurality of data files that may be used to design and build supply chain simulation files 119. Such files may include a part master dataset, a transaction demand dataset, and a bill of distribution dataset. These files may serve as a purified master record and may be used to provide information associated with each of the part numbers in the supply chain that satisfy the data requirements established in connection with the purification process. Accordingly, information included in the part master dataset, transaction demand dataset, and bill of distribution dataset has been filtered to exclude data that does not conform to the statistical requirements of the supply chain analysis process.

The part master dataset may be a record that embodies the master list of parts stored in inventory, excluding those part numbers removed by the data purification process. The part master dataset may include a listing of each part that has passed the purification process. The part master dataset may include the part number, the “common name” associated with the part, the facility or facilities that stock the part number, cost, vendor lead time, the location where the part number is stored in each inventory warehouse (e.g., bin number, shelf number, etc.), and any other general data associated with each of the part numbers in the supply chain.

The transaction demand dataset may be a record that includes information related to the sale of a part number from each of the plurality of facilities by a customer or other facility. For example, at a regional distribution or storage facility, the transaction demand dataset may include the sales of each part number to other distribution facilities or to retail centers in the supply chain network.

The bill of distribution dataset may be a record that includes sourcing information associated with each part number of the part master dataset. For example, the bill of distribution dataset may include, for each part number at a particular facility, a list of the facility (or facilities) within the supply chain network that are sources for replenishing inventory of the part. By evaluating the bill of distribution dataset for each part number along with transactional demand for the part number at the various locations within the bill of distribution chain, system 110 and inventory managers may be able to accurately predict inventory levels for each facility that are required to meet transactional demand at each facility in the distribution network.

According to one embodiment, the supply chain simulation file generation process may include stratification of the purified data to identify patterns and trends between data associated with part numbers or groups of part numbers that share certain attributes in common. For example, historical supply chain data 140 may be stratified according to cost to identify demand trends as a function of cost. Other examples of stratification criteria include unit sales, demand lines, lead time, deviation of demand, new parts, or any other stratification criteria that may aid in determining the supply chain optimization for a part number or a group of part numbers.

According to another exemplary embodiment, the supply chain simulation file generation process may also include submission of the stratified data to the client (e.g., and inventory manager, subscriber 130a, 130b) for validation of any trends identified by the stratification process. The validation step serves as an initial check on the purified and stratified data, to provide confirmation that the trends associated with the stratified and purified historical supply chain data conform to the trends noted by the client, prior to the process of building simulation files 119, which may be somewhat time-consuming. Such validation may ensure that the data purification and stratification processes do not have an adverse impact of the accuracy of the raw supply chain data.

If the client notes that the stratified and purified data is not consistent with historical supply chain data 140 or trends associated therewith, data may be re-collected, purified, and stratified again. If, on the other hand, the client confirms that the stratified and purified data remains consistent with historical supply chain data 140, indicating that the purification and stratification process did not significantly compromise the accuracy of the raw (i.e., unfiltered, unstratified) historical supply chain data, the supply chain simulation files 119 may be generated based on the purified and/or stratified data.

The process of building supply chain simulation files 119 may be an automated process, a manual process, or a combination of automated and manual processes designed to generate supply chain software models that, when simulated by a processor as part of a simulation software computer application, generate results consistent with the characteristics and behavior of the actual supply chain from which the models were derived. As such, supply chain simulation files, as part of a supply chain analysis package, may allow users to determine how certain changes in supply chain parameters may affect the operation and performance of the supply chain prior to making parametric changes in the actual supply chain.

Supply chain simulation files 119 may include a bill of distribution file (not shown), a transactional demand file (not shown), and a part master file (not shown), which may be generated based on a part master dataset, a transaction demand dataset, and a bill of distribution dataset coupled with growth and other characteristic trends identified during the stratification process. For example, the bill of distribution file may be generated based on the bill of distribution dataset gathered from historical supply chain data 140 as well as trends in the bill of distribution based on inventory growth projections derived from the stratified data. Similarly, transactional demand file may be generated by applying future transactional trends identified by the stratification process to the transaction demand dataset corresponding to historical supply chain data 140.

Once supply chain simulation files 119 have been generated, the files may be loaded onto system 110, for use with supply chain simulation software tools associated therewith. Such supply chain software simulation tools may provide an interface that allows a user to establish supply chain settings for one or more of the supply chain simulation files (Step 203). The capability to adjust supply chain settings, also referred to as “dials”, allows users (e.g., supply chain managers, logistics service providers, and/or subscribers 130a, 130b) to modify certain characteristics associated with the supply chain. Supply chain simulation files 119 may then be simulated under the conditions specified by the supply chain settings to predict how the user-specified adjustments affect the supply chain.

According to one exemplary embodiment, supply chain simulation files 119 may be validated using simulation software associated with system 110. For example, supply chain dials associated with supply chain simulation files 119 may be set to conditions that correspond to the conditions that are currently implemented by a supply chain of the client. Each of supply chain simulation files 119 may then be simulated and the results of the simulation may be compared with the statistics associated with the actual conditions. By setting the supply chain dials to current conditions and comparing the simulation results with the actual behavior, the user may determine the accuracy of the model. More specifically, high correlation between simulated results and the current statistics implies that the model is accurate, while low correlation between the simulated results and the current statistics may imply that one or more of supply chain simulation files 119 may be inaccurate or otherwise contain errors.

Once supply chain settings have been established, each of supply chain simulation files 119 may be simulated to predict performance associated with various aspects of the supply chain based on the established supply chain settings. For example, simulation software associated with system 110 may, when prompted by a user, simulate one or more forecast model(s) 119a and inventory planning model(s) 119b associated with supply chain simulation files 119 (Steps 204a and 204b.) Once forecast model 119a and inventory planning model 119b have been simulated for the first time, system 110 may simulate transactional model 119c (Step 205) to predict the operation and performance of the supply chain based on the supply chain settings established in Step 203. For example, system may predict certain supply chain performance parameters such as, among other things, service level associated with each part number or group of part numbers, costs associated with the supply chain, part turnover rates, part stock and overstock levels, part replenishment requirements (frequency), replenishment minimum and maximum values, sales volume for each part, or any other suitable performance parameter.

Once supply chain performance has been predicted through simulation of the supply chain simulation files, the predicted operation/performance data may be compared with target performance criteria (Step 206). Target performance criteria may include one or more operational or performance benchmarks established by the user. Target performance criteria may include, for example, a target service and/or an inventory level associated with the supply chain, a supply chain management budget that sets forth the maximum acceptable cost allocated by the client for supply chain management, or any other criteria that may be established by the user to evaluate performance results from the supply chain simulation.

If the predicted operational/performance parameters of the supply chain fail to meet the target performance parameters (Step 206: No), the user may be prompted to modify one or more of the supply chain settings associated with the simulation file and re-simulate one or more of supply chain simulation files 119 based on the modified conditions (Step 207). Consequently, system 110 may provide a solution that allows a user to iteratively analyze performance of a supply chain based on different sets of supply chain settings until a desired set of performance criteria has been met.

If, on the other hand, the predicted operation/performance data parameters meet the target performance criteria (Step 206: Yes), system 110 may generate a supply chain management report, for reporting one or more sets of supply chain settings that cause the supply chain to perform in accordance with the target performance parameters established by the subscriber (Step 208). Operation/performance criteria associated with the simulation may be provided to the user (or a potential customer, client, and/or subscriber(s) 130a, 130b) to quantitatively illustrate how the supply chain performance (cost, service level, stock levels, minimum and maximum replenishment levels, etc.) of the supply chain would have improved (or otherwise have changed) had the simulation solution been implemented during that time period. This “reverse-looking” analysis tool may allow users to measurably compare how a past supply chain performance may have been improved had features and methods associated with the presently disclosed embodiments been implemented.

It is contemplated that, although FIG. 2 illustrates certain processes associated with the simulation of forecast model, inventory planning model, and transactional model occurring independently; the processes may be carried out in series, whereby one or more of the simulation processes are executed chronologically before one or more of the other processes.

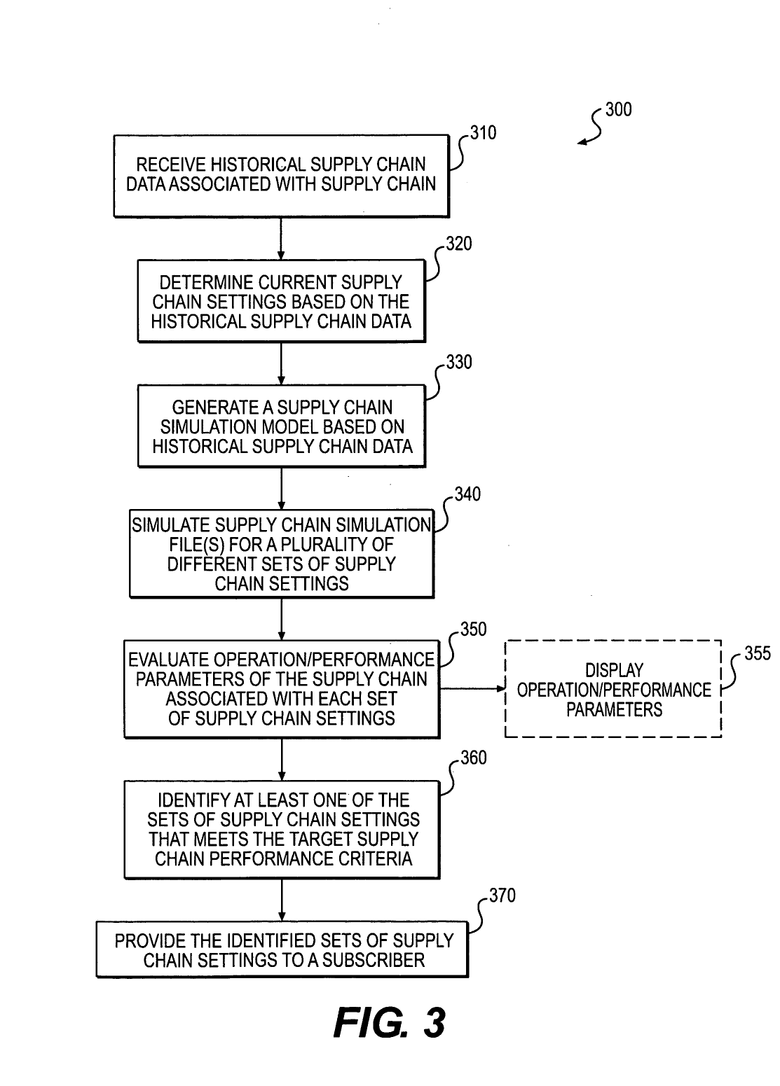

FIG. 3 provides a flow diagram depicting an exemplary method for estimating supply chain settings in order to improve supply chain performance. As illustrated in FIG. 3, historical supply chain data associated with the customer supply chain may be received/collected (Step 310). Supply chain operation/performance information including, for example, current cost and service level statistics corresponding with the historical supply chain data, may be determined based on the historical supply chain data (Step 320). According to one embodiment, operation/performance data associated with the supply chain may be estimated or inferred based on the historical supply chain data provided by the customer. Alternatively or additionally, the customer may provide operation/performance statistics based on internal accounting measures that may be implemented by the customer.

Once historical supply chain data and supply chain operation/performance data has been collected and/or determined, a supply chain simulation model may be generated (Step 330). As explained, the supply chain simulation model may be based on the historical supply chain data using the supply chain simulation file generation processes described above, in connection with FIG. 2. As previously explained, the supply chain simulation model allows users of system 110 to predict, through the use of supply chain simulation software, how changes in supply chain parameters effect the operation and performance of the supply chain. Such simulations provide a tool for testing and analyzing the supply chain's reaction to specific modifications before such changes are incorporated into the supply chain, thereby reducing the level of unpredictability associated with implementation of such modifications.

System 110 may simulate the supply chain model under a plurality of supply chain settings, each of the plurality of supply chain settings including a different variation of supply chain dials for the supply chain (340). As part of the simulation process, system 110 may evaluate the operation/performance data associated with each of the plurality of supply chain settings (Step 350). For example, for each set of supply chain settings, system 110 may generate estimated operation and/or performance statistics (cost, service level, etc.) associated with the supply chain based on the set of supply chain settings under evaluation.

According to one exemplary embodiment, once supply chain operation/performance data associated with the plurality of supply chain settings has been estimated, system 110 may store/display the estimated performance data (Step 355). For example, system 110 may generate a data graph that illustrates cost and service level (as a function of cost). Data points associated with simulations of the supply chain model performed at a plurality of different supply chain settings may be displayed on the graph, along with the actual current cost and service level data point of the supply chain. System 110 may also display target cost and target service level specified by subscriber 130a, 130b.

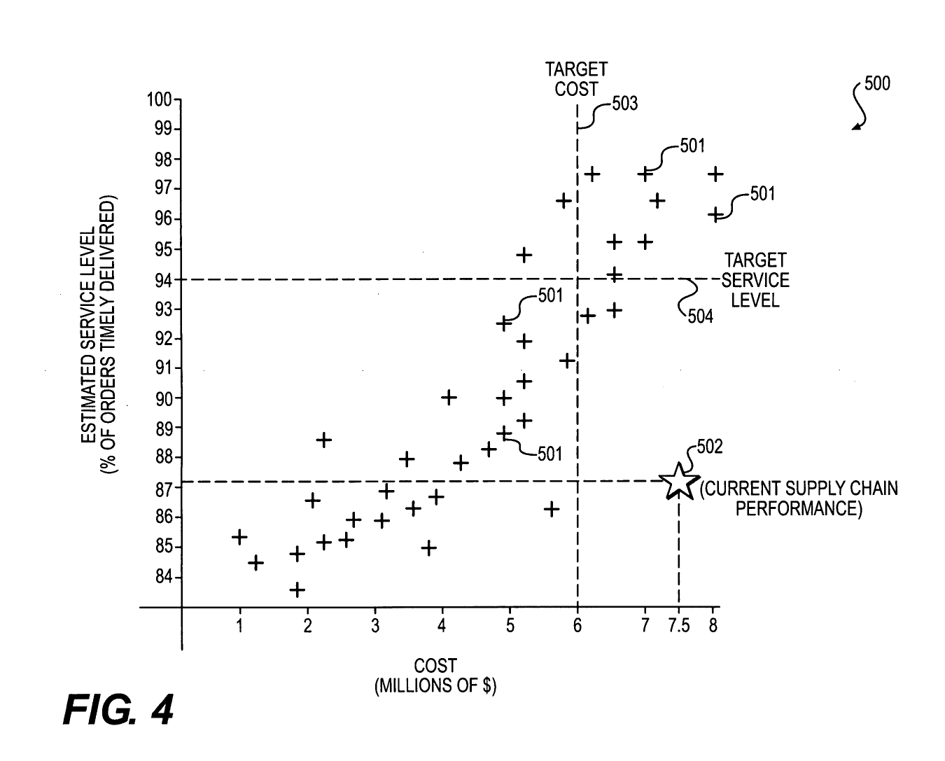

Upon completion of the simulation process, system 110 (or simulation software associated therewith) may identify at least one of the plurality of supply chain settings that meets the target performance criteria established by the user (Step 360). In addition, system 110 may provide the identified plurality of supply chain settings that meets the target performance criteria to subscriber 130a, 130b (Step 370). Alternatively or additionally, system 110 may provide supply chain management assessment report(s) 145 summarizing the supply chain settings analysis process and a graph depicting the performance data points associated with each supply chain dial setting simulation. An exemplary embodiment of such a diagram is illustrated in FIG. 4. Although the performance parameters shown in FIG. 4 are cost and service level, it is contemplated that system 110 may be configured to display any performance parameter (or groups of parameters) associated with the supply chain.

FIG. 4 provides an exemplary output 500 of system 110, which may be provided with supply chain management assessment report(s) 145. Output 500 depicts a plurality of cost and service level data points (501), each data point associated with a set of supply chain dial settings that were simulated using a supply chain simulation model. Output 500 may also include a data point (502) associated with current cost and service level associated with the current supply chain settings for the supply chain. Optionally, output 500 may include a cost reference (503) and service level reference (504), displaying the target cost and/or target service level provided by subscriber 130a, 130b.

### INDUSTRIAL APPLICABILITY

Systems and methods consistent with the disclosed embodiments provide a solution for improving performance of a supply chain by allowing users to evaluate supply chain performance by creating a simulation model associated with an existing supply chain and simulating the model under different sets of supply chain settings, until a desired level of performance of the supply chain has been met. Consequently, supply chain environments that employ processes and features associated with the disclosed embodiments may realize an increase in the performance, reliability, and profitability of a supply chain, without having to employ “trial and error”-based evaluations on the actual supply chain.

Although the disclosed embodiments are described and illustrated as being associated with supply chain management environments for parts distribution, they may be applicable to any process where it may be advantageous to simulate supply chain models under a plurality of different conditions to identify potential improvement in the performance of the supply chain. Furthermore, the presently disclosed systems and methods for improving supply chain performance may be integrated as part of a logistics service for improving and/or optimizing cost and service level performance associated with existing supply chain infrastructure. Alternatively or additionally, the systems and methods described herein may be provided as part of a software package that allows users to analyze how changes to existing supply chain processes may impact cost and service level associated with a supply chain.

The presently disclosed systems and methods for estimating settings associated with a supply chain may have several advantages. For example, unlike some conventional software simulation tools that use “off-the-shelf” or “best-fit” supply chain simulation models, the presently disclosed software tool allows users to construct highly-customized, customer-specific software simulation files, based on historical supply chain data provided by a customer. As a result, the presently disclosed software tool may predict supply chain performance with substantially greater precision than conventional simulation tools that use generic supply chain simulation models.

Furthermore, systems and methods described herein provide a supply chain simulation process that allows models associated with one or more features of supply chain performance (e.g., forecast, inventory planning, or transactional) to be simulated separately and independently from the other aspects. In contrast with some conventional supply chain simulation solutions, which require that each feature of supply chain performance be simulated during each iteration, the presently disclosed simulation solution allows users to customize the simulation process to bypass the simulation of certain features of supply chain performance. Accordingly, organizations that implement the systems and methods described herein may realize significant time savings, particularly when the simulation process may require multiple iterations to arrive at target supply chain performance criteria.

It will be apparent to those skilled in the art that various modifications and variations can be made to the disclosed systems and methods for estimating settings associated with a supply chain without departing from the scope of the disclosure. Other embodiments of the present disclosure will be apparent to those skilled in the art from consideration of the specification and practice of the present disclosure. It is intended that the specification and examples be considered as exemplary only, with a true scope of the present disclosure being indicated by the following claims and their equivalents.

What is claimed is:

1. A method for estimating supply chain settings, comprising:
receiving historical supply chain data associated with a supply chain;
generating one or more supply chain simulation files based on the historical supply chain data;
establishing a plurality of supply chain settings associated with the one or more supply chain simulation files;
simulating the one or more supply chain simulation files based on the plurality of supply chain settings;
predicting performance of the supply chain over a time period associated with the historical supply chain data based on the simulation; and
outputting data indicative of the predicted performance of the supply chain.

2. The method of claim 1, wherein outputting data indicative of the predicted performance of the supply chain includes generating a report comparing data indicative of the predicted performance with data indicative of a previous supply chain performance over the time period associated with the historical supply chain data.

3. The method of claim 1, wherein predicting performance of the supply chain includes:
simulating a forecast model to estimate a demand for each of a plurality of part numbers associated with the supply chain;
simulating an inventory planning model to estimate one or more inventory planning characteristics for each of the plurality of part numbers; and
simulating a transactional model to estimate supply chain transactions for each of the plurality of part numbers.

4. The method of claim 3, further including:
adjusting one or more of the plurality of supply chain settings;
re-simulating the one or more supply chain simulation files based on the one or more adjusted supply chain settings; and
predicting performance of the supply chain based on the re-simulating of the one or more supply chain simulation files.

5. The method of claim 4, wherein re-simulating the one or more supply chain simulation files includes re-simulating one or more of the forecast model, the inventory planning model, and the transactional model.

6. The method of claim 5, wherein the transactional model may be re-simulated without requiring re-simulation of the forecast model or the inventory planning model.

7. The method of claim 5, wherein the forecast model may be re-simulated without requiring re-simulation of the inventory planning model.

8. The method of claim 5, wherein the inventory planning model may be re-simulated without requiring re-simulation of the forecast model.

9. The method of claim 3, wherein one or more of the forecast model or the inventory planning model is provided by a subscriber.

10. A computer-readable medium for use on a computer system, the computer-readable medium including computer-executable instructions for performing a method for estimating control settings in a supply chain environment, the method comprising:
generating one or more supply chain simulation files based on historical supply chain data associated with a supply chain;
establishing a plurality of supply chain settings associated with the one or more supply chain simulation files;
simulating the one or more supply chain simulation files based on the plurality of supply chain settings;
predicting performance of the supply chain over a time period associated with the historical supply chain data based on the simulation; and
outputting data indicative of the predicted performance of the supply chain.

11. The computer-readable medium of claim 10, wherein outputting data indicative of the predicted performance of the supply chain includes generating a report comparing data indicative of the predicted performance with data indicative of a previous supply chain performance over the time period associated with the historical supply chain data.

12. The computer-readable medium of claim 10, wherein predicting performance of the supply chain includes:
simulating a forecast model to estimate a demand for each of a plurality of part numbers associated with the supply chain;
simulating an inventory planning model to estimate one or more inventory planning characteristics for each of the plurality of part numbers; and
simulating a transactional model to estimate supply chain transactions for each of the plurality of part numbers.

13. The computer-readable medium of claim 12, the method further including:
adjusting one or more of the plurality of supply chain settings if the predicted performance of the supply chain is not within a threshold range of target performance criteria;
re-simulating the one or more supply chain simulation files based on the one or more adjusted supply chain settings; and
predicting performance of the supply chain based on the re-simulating of the one or more supply chain simulation files.

14. The computer-readable medium of claim 13, wherein re-simulating the one or more supply chain simulation files includes re-simulating one or more of the forecast model, the inventory planning model, and the transactional model.

15. The computer-readable medium of claim 14, wherein the transactional model may be re-simulated without requiring re-simulation of the forecast model or the inventory planning model.

16. The computer-readable medium of claim 14, wherein the forecast model may be re-simulated without requiring re-simulation of the inventory planning model.

17. The computer-readable medium of claim 14, wherein the inventory planning model may be re-simulated without requiring re-simulation of the forecast model.

18. A method for estimating supply chain settings, comprising:
receiving historical supply chain data associated with a supply chain;
generating one or more supply chain simulation files based on the historical supply chain data;
establishing a plurality of supply chain settings associated with the one or more supply chain simulation files;
predicting performance of the supply chain over a time period associated with the historical supply chain data by simulating the one or more supply chain simulation files based on the plurality of supply chain settings;
comparing predicted performance of the supply chain with target performance criteria; and
adjusting actual supply chain settings based on the predicted performance of the supply chain.

19. The method of claim 18, further comprising generating a report comparing data indicative of the predicted performance with data indicative of a previous supply chain performance over the time period associated with the historical supply chain data.

20. The method of claim 18, further including:
adjusting one or more of the plurality of supply chain settings if the predicted performance of the supply chain is not within a threshold range of target performance criteria;
re-simulating the one or more supply chain simulation files based on the one or more adjusted supply chain settings; and
predicting performance of the supply chain based on the re-simulating of the one or more supply chain simulation files.
